(19) United States
(12) Patent Application Publication
(10) Pub. No.: US 2026/0136251 A1
(43) Pub. Date: May 14, 2026

(54) FORWARD COMPATIBILITY SIGNALING FOR REDUCED CAPABILITY FEATURES

(71) Applicant: QUALCOMM Incorporated, San Diego, CA (US)

(72) Inventor: Masato KITAZOE, Tokyo (JP)

(21) Appl. No.: 18/948,347

(22) Filed: Nov. 14, 2024

(51) Int. Cl. H04W 36/08; H04W 36/00

(52) U.S. Cl. CPC H04W 36/08; H04W 36/0061

(57) ABSTRACT

Certain aspects of the present disclosure provide techniques for wireless communications. An example method includes receiving capability information associated with a user equipment (UE), the capability information including a field with a plurality of bit positions, each bit position corresponding to a respective feature of a plurality of features, wherein a first set of features of the plurality of features are supportable by the network entity and a second set of features are unsupportable by the network entity; and communicating in accordance with the capability information.

### INTRODUCTION

### Field of the Disclosure

Aspects of the present disclosure relate to wireless communications, and more particularly, to techniques for forward compatibility signaling for reduced capability features.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a network entity. The method includes receiving capability information associated with a user equipment (UE), the capability information including a field with a plurality of bit positions, each bit position corresponding to a respective feature of a plurality of features, wherein a first set of features of the plurality of features are supportable by the network entity and a second set of features are unsupportable by the network entity; and communicating in accordance with the capability information.

Certain aspects provide a method for wireless communications by a UE. The method includes sending capability information, the capability information including a field with a plurality of bit positions, each bit position corresponding to a respective feature of a plurality of features, wherein a first set of features of the plurality of features are supportable by the UE and a second set of features are unsupportable by the UE; and communicating in accordance with the capability information.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts an example of UE mobility in a wireless communications network.

FIG. 6 depicts a process flow for forward compatibility signaling for reduced capability features.

FIG. 7 depicts a process flow for forward compatibility signaling for reduced capability features in a UE mobility context.

FIG. 8 depicts an example field for forward compatibility signaling for reduced capability features.

FIG. 9 depicts a method for wireless communications.

FIG. 10 depicts another method for wireless communications.

FIG. 11 depicts aspects of an example communications device.

FIG. 12 depicts aspects of an example communications device.

### DETAILED DESCRIPTION

Aspects of the present disclosure provide apparatuses, methods, processing systems, and computer-readable mediums for forward compatibility signaling for reduced capability features.

A user equipment (UE) may communicate with a network entity using a radio access technology (RAT). A RAT may support certain features for the communication between the UE and the network entity. Not all UEs may support all features of a RAT, and not all network entities may support all features of a RAT. Thus, a UE and a network entity may support the exchange of “capability information” in the network for the purpose of providing the UE with communication services that conform to the features supported by both the UE and the network entity. For example, capability information for the UE may include information about parameters that a UE may use to access an access network, such as a power class, a supported frequency band, a supported carrier aggregation (CA) band combination, a supported duplexing mode, a supported traffic profile (e.g., voice centric, data centric, etc.), a supported radio bearer configuration, or the like.

In some cases, a first UE may support a given feature and a second UE (which, for example, may support an earlier version of a RAT than the first UE) may not support the given feature. For example, the implementation of features in a wireless communications network may be managed through a system of parallel versions, such as “Releases,” that provide a stable platform for the implementation of features at a given point. This system then allows for the addition of new functionality in subsequent versions or Releases. A later version (e.g., Release) may be fully backward compatible with an earlier version (e.g., Release). For example, a later version may be mandated not to render any feature of the earlier version inoperable. Furthermore, a network entity that deploys an earlier version may “gracefully” process signaling messages designed for later versions by ignoring new features of the signaling messages which the network entity does not understand.

There may be a discontinuity between the functionality and capabilities of network entities in the wireless communications network depending on the current version of a RAT that has been deployed on a given network entity. For example, a UE may have deployed a later version of the RAT (including a larger set of features) while a nearby network entity may have deployed an earlier version of the RAT (including a smaller set of features). Generally, in this situation, the capability information provides a way for the UE and the network entity to come to a common understanding of which features can be used for communication between the UE and the network entity. However, in some situations, as will be seen, the behavior of the network with respect to the capability information presents a technical challenge to this design.

Some wireless communications networks may support reduced capability (RedCap) devices. A RedCap device may be a type of UE. RedCap facilitates the expansion of the device ecosystem to cater to use cases that are not served well by full-bandwidth or full-power communication. For instance, RedCap devices may be useful in scenarios involving sparse power supply, such as an inconsistent power supply or power supply derived from an environment of the reduced capability device, long field deployment, where an instrument or a sensor may be deployed away from maintenance or power, and/or low communication requirements such as infrequent communication, low-complexity communication feature set support, low throughput, or low data rate. An example of a reduced capability device is an ambient Internet of Things (A-IoT) device.

The reduced capability features of RedCap devices are intended to reduce baseband complexity and provide bandwidth reduction. Such reduced capability features are also intended to reduce the maximum number of MIMO layers and implement relaxation of the maximum downlink modulation order. A collateral effect of reduced capability features is to reduce overall device hardware component costs, e.g., fewer antennas and RF components, by reducing the minimum number of required receive branches and allowing half-duplex (HD) operations in all bands. However, another collateral effect of support of reduced capability features is that RedCap devices are sometimes unable to connect to legacy networks because the supported features are reduced capabilities. Similarly, legacy networks (that do not support reduced capability features) may be unaware of a RedCap device's status as a RedCap device, assuming instead that all UEs have full capabilities in the areas described above.

In a typical exchange, a UE performs an exchange of capability information with a network entity, where the network entity sends an inquiry to the UE for the capability information and the UE sends its capability information in response to the inquiry. If the UE supports a different (e.g., later) version of the RAT than the network entity, then the network entity may not be capable of parsing all of the capability information provided by the UE. In many situations, this is not problematic, since the “baseline” set of features supported by a UE may be compatible with the baseline set of features supported by a network entity. However, this may be problematic for a RedCap device since the baseline set of features supported by a network entity may exceed the capabilities of a RedCap device. If a network entity configures a RedCap device to communicate using a feature set (e.g., bandwidth, band combination, CA combination, frequency range) that is a baseline feature set but exceeds the capability of the RedCap device, communication failure may occur between the network entity and the RedCap device that would not occur between the network entity and a baseline (e.g., eMBB) UE.

Aspects described herein relate to techniques for providing generic forward-compatible signaling for indicating the presence of reduced capability features. For example, a UE may send, and a network entity may receive, capability information that includes a field comprising a plurality of bit positions. The field may be defined such that network entities or UEs supporting a given version of a radio access technology are aware of the presence of the field and can parse the content of the field (that is, values of the plurality of bit positions). A UE or network entity supporting a version later than the given version may be aware of a feature associated with a specific bit position (or set of bit positions) of the field. A UE or network entity supporting only the given version (and not the later version) may not be aware of the feature associated with the specific bit position (or set of bit positions), but may be capable of parsing the general presence of the field and the value of the specific bit (or set of bits) in the bit position(s). In the event that the network entity does not support the feature, the network entity may reject the connection request from the UE. In another example, a moving RedCap device may experience a handover between a source network entity and a target network entity. The source network entity may compare received capability information to known capability information of the target network entity (e.g., using the field) and may only configure or allow a handover if a match is found for one or more bit positions in the field.

Certain techniques for providing generic forward compatibility signaling between network nodes may have the technical benefit of improving the efficiency of the network by preventing extraneous connections from being established. The addition of a field to the UE capabilities message allows the network entity to quickly reject a connection request from the UE when the UE is a RedCap device that supports a feature unsupported by the network entity, such that the UE can move on to another network entity that may support the reduced capability features.

Another technical benefit of the techniques described herein are to improve power consumption and/or compute resource usage by a UE or network entity. For example, the UE and/or the network entity will not waste time or energy in negotiating a connection that cannot be established, which may be especially beneficial if the UE is in a low battery state or if compute resources, such as processing, memory or storage resources, are at a premium. By providing a field that indicates the reduced capabilities for all network entities supporting at least a given version of a radio access technology, a network entity is able to decide quickly to reject a connection and free up compute resources for other processes even if the network entity does not support a later version of the radio access technology. This also reduces total resource usage, and therefore power usage, because the legacy connection request is rejected.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

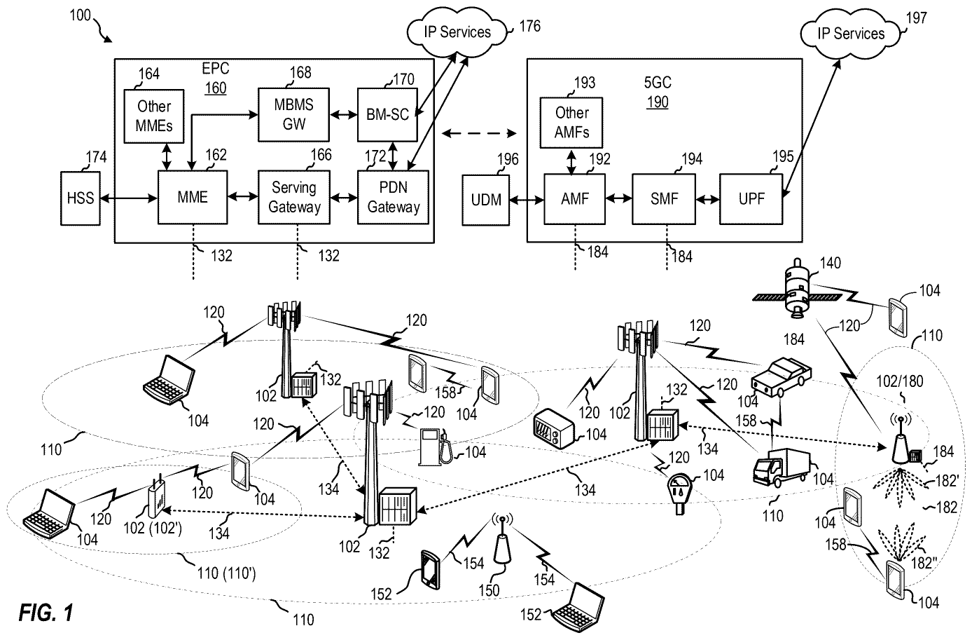

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

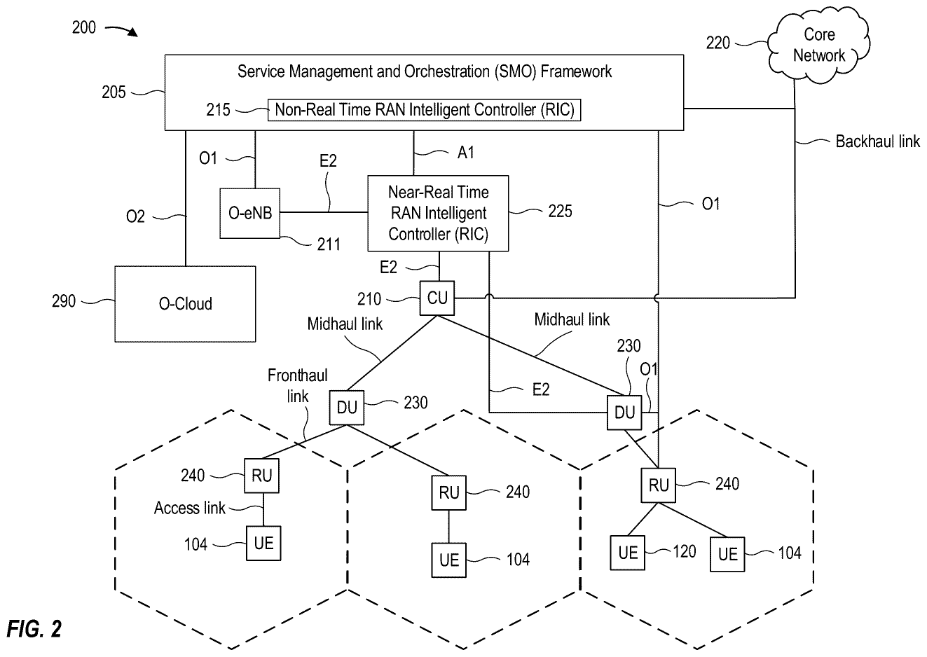

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5 GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1 ) as including 410 MHz-7125 MHz, which is often referred to (interchangeably) as “Sub-6 GHz”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

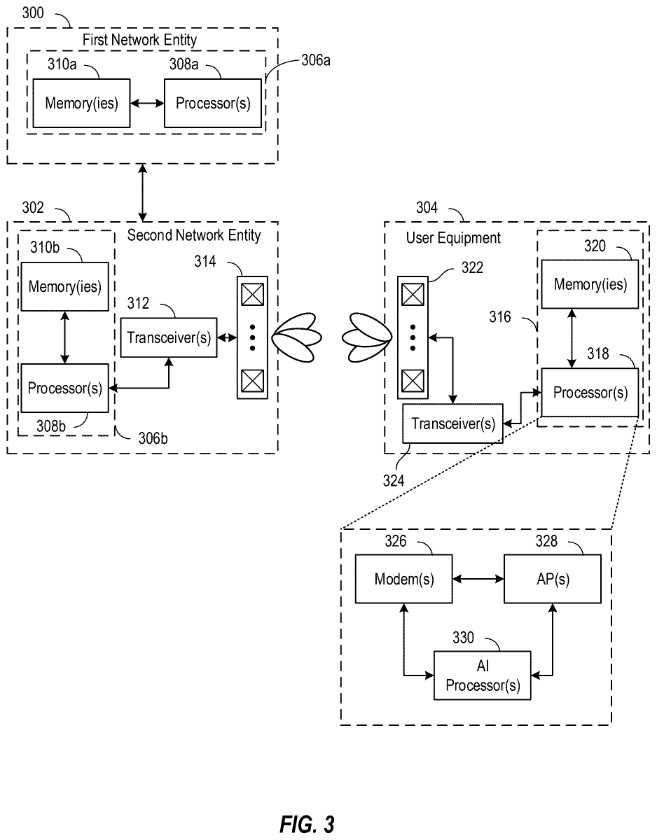

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306a” at first network entity 300 and “processing system 306b” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308a” and “processor(s) 308b”) and one or more memories 310 (illustrated as “memory(ies) 310a” and “memory(ies) 310b”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a TX MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, an RX MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for SC-FDM), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306b such as a modem and/or an RX MIMO detector), and further processed by the processing system 306b (e.g., a modem and/or a receive processor) to obtain decoded data and control information sent by UE 304. The processing system 306b may provide the decoded data and the decoded control information (such as to a controller/processor of the processing system 306b, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

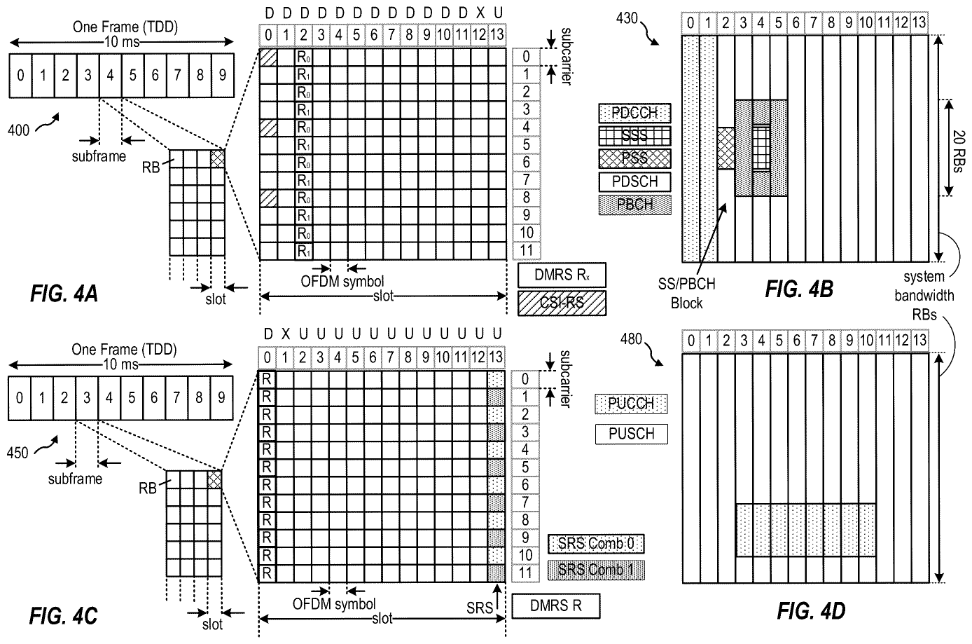

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ} slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Example Mobility Management

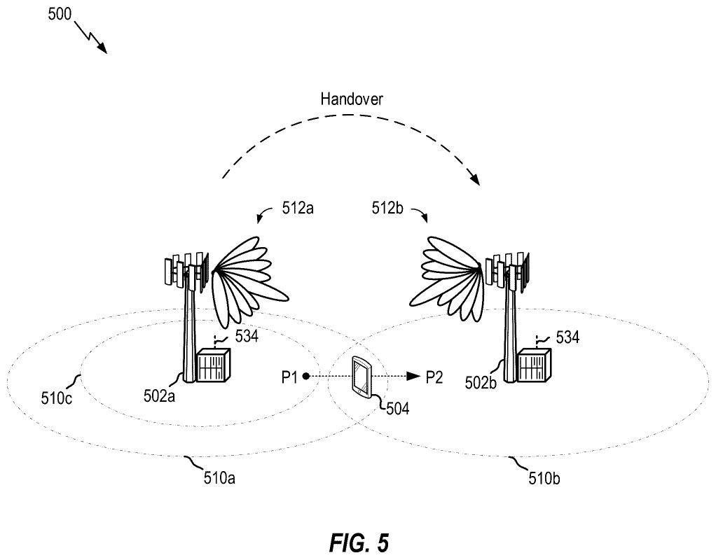

FIG. 5 depicts an example of UE mobility in a wireless communications network 500. In this example, the wireless communications network 500 may include a first network entity 502a having a first coverage area 510a and a second network entity 502b having a second coverage area 510b, which may overlap with the first coverage area 510a. The first network entity 502a may also have a third coverage area 510c. In certain aspects, the first coverage area 510a may form a first cell, the second coverage area 510b may form a second cell, and the third coverage area 510c may form a third cell. The first cell and third cell may form a first cell group, and the second cell may form a second cell group. The first network entity 502a may communicate via a first set of beams 512a, and the second network entity 502b may communicate via a second set of beams 512b.

Due to mobility (e.g., a UE 504 moving from the first coverage area 510a to the second coverage area 510b), the UE 504 may transition from communicating with the first network entity 502a via the first set of beams 512a to communicating with the second network entity 502b via the second set of beams 512b. As an example, the UE 504 may be located at a first position P1 in the first coverage area 510a and/or the third coverage area 510c at a first occasion, and then the UE 504 may move to a second position P2 in the second coverage area 510b at a second, later occasion.

In some cases, the UE 504 may send a measurement report to the first network entity 502a. For example, the first network entity 502a may configure the UE 504 to measure a set of neighboring cell(s) and/or beam(s) of one or more neighboring network entities (e.g., the second network entity 502b). In some cases, the UE 504 may identify neighboring cell(s) and/or beam(s) of a neighboring network entity, for example, via signaling transmitted by the neighboring network entity. The neighboring cell(s) and/or beam(s) may be or include candidate communication link(s) that the UE can handover or switch to from the cell(s) and/or beam(s) of the first network entity 502a. As an example, the neighboring cell(s) and/or beam(s) may include the second cell of the second coverage area 510b and/or the second set of beams 512b. The measurement report may indicate radio measurements (e.g., signal strengths) associated with the serving cell of the first network entity 502a and/or neighboring cell(s), such as the cell(s) of the second network entity 502b. In certain cases, the measurement report may indicate the signal strengths associated with certain beam(s) of the serving cell and the neighboring cell(s), such as the first set of beams 512a and/or the second set of beams 512b. Based on the measurement report (e.g., indicating a stronger signal strength associated with radio measurements for the second network entity 502b relative to the first network entity 502a), the first network entity 502a may determine to handover (HO) communications with the UE 504 to the second network entity 502b. The first network entity 502a may be in communication with the second network entity 502b via a backhaul link 534 (e.g., an F1, Xn, and/or NG interface) in order to exchange information for the handover.

In the context of a handover or mobility operation, the first network entity 502a may be referred to as a source network entity and the second network entity 502b may be referred to as a target, candidate, neighbor, or neighboring network entity, depending on the stage of the handover or mobility operation. As part of a handover, the source network entity transfers a connection with a UE to a target network entity. A candidate or neighboring network entity may be a possible target for the handover, and in some cases, the candidate or neighboring network entity may communicate via candidate cell(s) and/or beam(s) having coverage area(s) adjacent to or overlapping with the coverage area(s) of the source network entity.

In some cases, the handover may involve a CU/DU handover, such as inter-DU-intra-CU handover and/or inter-CU handover. For example, the handover may involve a handover from a source DU to a target or candidate DU in communication with a common CU (e.g., inter-DU-intra-CU handover). In some cases, the handover may involve a handover from a source CU to a target or candidate CU (e.g., inter-CU handover). Accordingly, the first network entity 502a and/or the second network entity 502b may be an example of an RU, DU, and/or CU.

Note that the handover illustrated in FIG. 5 is an example of a mobility operation. Aspects of the present disclosure described herein may be applied to various types of UE mobility operations including, for example, (conditional) lower-layer triggered mobility (LTM), L3 mobility, an Xn based handover, an N2 based handover, conditional handover, beam selection, beam switch, (conditional) serving cell modification or change, (conditional) serving cell addition, (conditional) serving cell release, cell group modification, cell group addition, cell group release, dual active protocol stack (DAPS) handover, dual connectivity, or the like. A mobility operation or handover may be triggered, for example, due to radio conditions (e.g., in response to a measurement report), load balancing at a network entity, and/or a specific service (e.g., certain QoS specification(s) for communications are satisfied).

### Aspects Related to Reduced Capability Features

At the initiation of a connection between a UE and a network entity, or during a handover from a first network entity to a second network entity, a UE may signal its own capabilities to a network entity using RRC signaling. A request (e.g., the UECapabilityEnquiry message), is typically initiated by the network entity, to which the UE typically responds with the capabilities of the UE (e.g., the UECapabilityInformation message). The specific capabilities of the UE may be returned to the network entity via a set of feature identifiers that is included in the response. Available UE capabilities signaled in this message are updated as features are added in the network, as will be described in more detail below.

In more recent versions of the network (such as later versions of a radio access technology used by the network), support for reduced capability features for UEs has been added to the network. As a result, reduced capability UEs are commonly deployed in the network. Reduced capability features are a “slimmed down” feature set designed to expand the 5G ecosystem and connect more devices to the network. One example of a reduced capability feature is a reduced device bandwidth for transmission and reception, e.g., 20 MHz for FR1 (instead of 100 MHz for a baseline NR device) and 100 MHz for FR2 (instead of 200 MHz for a baseline NR device). Another supported reduced capability feature is a reduced number of receive chains, resulting in fewer receive antennas and DL MIMO layers. For instance, in frequency bands where a baseline NR device is expected to support two receive chains, a reduced capability device is only expected to support one receive chain and corresponding DL MIMO layer. Similarly, in frequency bands where a baseline NR device is expected to support four receive chains, a reduced capability device is expected to support no more than two receive chains. The reduced capability features that are supported in the network also include, but are not limited to, a relaxed expectation for DL modulation order, e.g., 64QAM as opposed to 256QAM in a baseline NR device, and potential operation in half-duplex FDD (HD-FDD) as opposed to an expectation of full-duplex FDD in baseline NR devices. Reduced capability devices are not expected to support carrier aggregation (CA) or dual connectivity (DC), and thus are expected to operate in a single frequency band at a time.

As noted elsewhere herein, new features may be introduced to a network in a versioned fashion. A network entity that is deployed with support for a given version may not support a later version unless the network entity is updated to support the later version. For example, the network entity supporting only the given version may fail to process signaling that is introduced in the later version. Thus, a legacy network entity would not support, or even be aware of, reduced UE capabilities due to the introduction of the reduced capability features in a later version of the network. In the establishment of a connection in the network, the capability information is exchanged between the UE and the network entity and, in the event that a network entity does not recognize certain features of a UE, the default behavior of a network entity is to use default settings for unrecognized features. In the event that a reduced capability UE attempts to connect to a legacy network entity, there may be inefficiency in the connection establishment because the default feature settings of a legacy network entity are above the capabilities of a reduced capability UE. For example, if the default setting in the legacy network entity device bandwidth for FR1 is 100 MHz, a reduced capability UE would not be able to connect since the UE is only capable of communication on a bandwidth of 20 MHz, as described above. Since this mismatch is not recognized by the network entity, network resources may be expended in establishing a connection that cannot succeed. A similar technical problem may occur if an updated network entity, e.g., one that supports reduced UE capabilities, has established a connection to a reduced capability UE and attempts to hand the UE over to a legacy network entity that does not support the reduced UE capabilities. The legacy network entity in this instance would again substitute default settings for unrecognized features, which are above the capabilities of the reduced capability UE. There is a need for forward compatibility signaling of reduced UE capabilities so that connection requests from a reduced capability UE, e.g., a UE deployed with a later version, to a legacy network entity, e.g., a network entity deployed with an earlier version, may be rejected quickly. Such forward compatibility signaling would allow the legacy network entity to be aware of the presence of reduced capability features in the UE that the legacy network entity cannot support.

As described herein, “forward compatibility” refers to a design characteristic that allows a system to accept input that is intended for or configured according to a later version of the system. For instance, a standard supports forward compatibility if a product, e.g., a UE or network entity, that complies with earlier versions, e.g., Releases, is capable of handling input designed for later versions, e.g., Releases.

Certain aspects herein provide a technical solution to the technical problem of forward compatibility signaling of reduced UE capabilities, such as providing techniques to include a field in the capability information that may be exchanged between entities in a network, e.g., between a UE and a network entity in a connection establishment context or between multiple network entities in a connection handover context. Such a field is comprised of bit positions that correspond to features of the UE, some of which may be supported by the network entity and some that may not be supported by the network entity. For example, these features may be reduced capability features. The UE may set the values of the bit positions in the UE's field according to its own capabilities and a network entity may set the value of the bit positions in the network entity's field according to the supported features of the network entity. In an exchange of capability information between the UE and network entity using the field, network entities may be alerted to the presence of reduced capability features based on the values of the bit positions in the field. In the event that a different value is detected in every bit position of the field received from the UE and the field of the network entity, the network entity may reject a connection or handover request. If there is a matching value of a bit position of the field received from the UE and the field of the network entity, the network entity may accept the connection or handover request (e.g., even if the UE also supports a feature that is unsupportable by the network entity). Alternatively, the network entity may reject the connection when the UE indicates support for a feature that is unsupportable by the network entity (for example, that is defined by a later version than a version supported by the network entity). This technique provides greater efficiency in the case of a reduced capability UE attempting to connect to a legacy network entity that does not support the reduced capability features by eliminating the practice of using default settings that may be above the capabilities of the UE.

As mentioned, the UE may set the values of the bit positions comprising the UE's field according to features that are supported by the UE. A network entity may also set the values of the bit positions of the network entity's field according to the supported features of the network entity. The network entity parses the field from the UE and compares the values of the bit positions of the received field to the values in the bit positions of the network entity's field using an appropriate method, e.g., a bitwise operator. For instance, if a UE supports no reduced capability features, e.g., a legacy UE or a full-featured UE, then no bit positions would be set in the field sent to a network entity. The network entity would parse the field and, since the UE has no reduced capability features, the network entity does not need to support the reduced capability features, in which case it does not matter if any bit positions are set in the field at the network entity. In this instance, a baseline network connection establishment process may be followed. However, if a bit position in the field has a value set by the UE due to the presence of a reduced capability feature of the UE, a network entity may parse the field and determine if the network entity supports the reduced capability feature. A supported reduced capability feature of the UE is also supported and supportable by the network entity if the value of the bit position in the field received from the UE matches the value of the same bit position in the field of the network entity. If no reduced capability features of the UE are also supported by the network entity (in other words, no bit position that is set by the UE in the field matches a bit position that is set in the field of the network entity), then the network entity rejects the connection request.

It should be noted that the network entity only expects to detect a mismatch in the bit positions of the field and need not recognize specific reduced capability features corresponding to the bit positions of the field. For example, if the UE supports half-duplex operation and sets a value of a bit position according to such support, then a network entity that does not support half-duplex operation parses the field and detects a mismatch because the network entity has not set the value of the same bit position at the network entity. The network connection request could be rejected if no other reduced capability features are supported by the network entity, meaning that no other bit positions that are set by the UE are also set by the network entity. However, the network entity is not expected to be aware of specific reduced capability features that are not supported, and, thus, in the current example, may not understand that the bit position corresponds to half-duplex operation. This also allows the network entity (in the case where the network entity is acting as a source network entity of a mobility operation) to accept or reject a handover request according to the field of the UE and a corresponding field of a target network entity, even if the source network entity is unaware of the features associated with one or more bit positions of the field (for example, if the target network entity and the UE support a later version than the source network entity).

### Example Signaling of Forward Compatibility of Reduced Capability Features

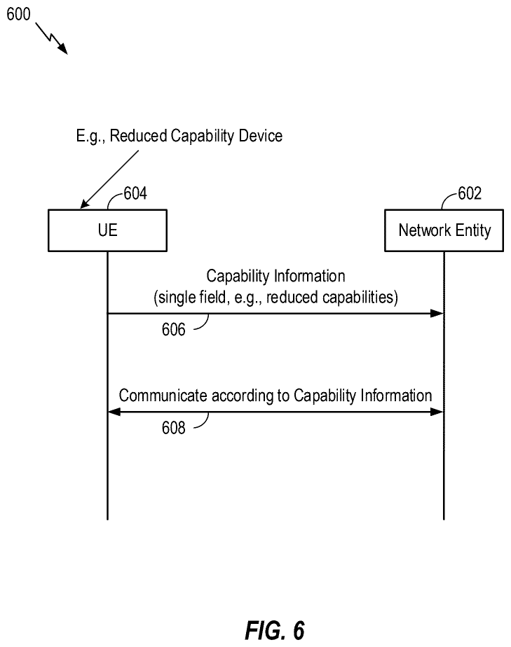

FIG. 6 depicts a process flow 600 for network connection establishment communications between a network entity 602 and a UE 604. In some aspects, the network entity 602 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 604 may be an example of UE 104 depicted and described with respect to FIG. 1 or the UE 304 depicted and described with respect to FIG. 3. However, in other aspects, UE 604 may be another type of wireless communications device and network entity 602 may be another type of network entity or network node, such as those described herein. Note that any operations or signaling illustrated with dashed lines may indicate that that operation or signaling is an optional or alternative example.

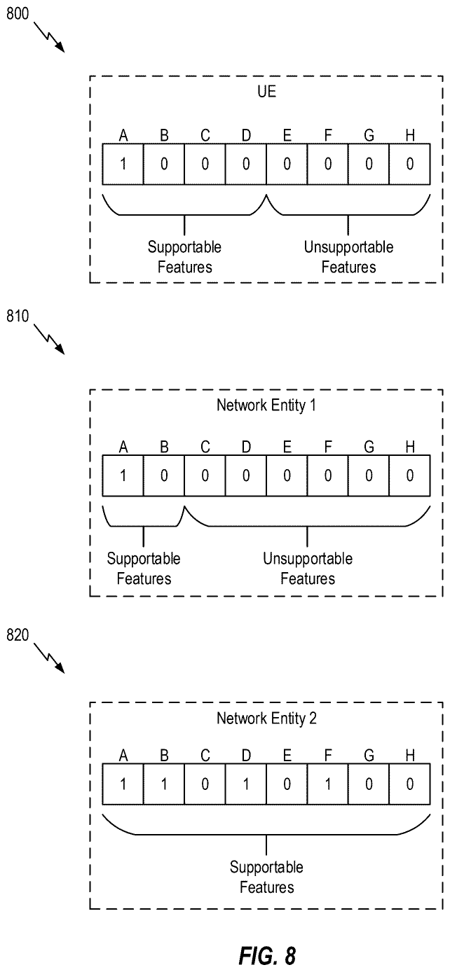

FIG. 6 illustrates a capability information exchange between UE 604 and network entity 602 using RRC signaling. At 606, UE 604 sends capability information for UE 604 to network entity 602. The capability information includes a field comprised of bit positions, where each bit position corresponds to a reduced capability feature that is supported by UE 604. For instance, one bit position may correspond to support for half-duplex, while another bit position may correspond to a supported level of DL modulation order, and further bit positions may correspond to supported reduced capability features at the UE 604, as will be described further in FIG. 8. In some examples, the UE is only capable of understanding those reduced capability features that are supported by the UE, and would not set any bit position corresponding to an unsupported feature. As a result, the UE 604 may not understand what feature corresponds to a bit position corresponding to unsupported features. In the example of FIG. 6, in the event that UE 604 is a reduced capability device, the UE 604 sets a value in at least one bit position in the field according to the reduced capabilities supported by the UE 604.

A feature that cannot be supported or comprehended by a UE 604 or network entity 602 may be referred to as an unsupportable feature. For example, an unsupportable feature may be introduced in a later version of a radio access technology than the version supported by a UE 604 or network entity 602 (e.g., “bit position 3 corresponds to a feature that is undefined in the version of the radio access technology that I support”). This is different from an unsupported or supportable feature, which is a feature for which a UE 604 or network entity 602 can comprehend the bit position (e.g., “bit position 3 corresponds to half-duplex”) and can indicate support or non-support according to the bit position.

The field may be a single field. For example, the field may be defined by a single parameter for capability information, meaning that any device that supports at least a version that introduces the field may be capable of parsing bit positions of the field. As another example, the field may be defined as a bit string, such as a BIT STRING using Abstract Syntax Notation number 1 (ASN.1), thereby enabling any device that supports at least a version that introduces the field to parse bit positions of the field.

At 608, network entity 602 and UE 604 may communicate according to the capability information sent by UE 604. As mentioned above, network entity 602 may implement the field with bit positions set according to the set of features supportable and supported by the network entity. For instance, as with the field received from the UE, one bit position may correspond to support for half-duplex at the network entity, while another bit position may correspond to the level of DL modulation order supported by the network entity. Network entity 602 may parse the field and compare the feature set of the UE 604 to the set of features supported by network entity 602 by comparing the two fields, e.g., the field received from the UE 604 and the field of the network entity 602.

In the event that at least one bit position is set in each field (for example, indicating the presence of reduced capability features) and at least one bit position that is set is also matched between the fields, as is the case when the network entity 602 supports at least one of the reduced capability features of UE 604, the network entity 602 may accept a connection request from the UE 604 according to the capability information (referred to herein as communicating according to the capability information). However, if no bit positions that are set are also matched between the two fields (that is, have the same value set), which is the case where network entity 602 does not support any of the reduced capability features of UE 604, then a connection request from UE 604 to network entity 602 is rejected (referred to herein as communicating according to the capability information). In certain aspects, the use of the field may allow the network to quickly reject a connection request between a UE, e.g., UE 604, and a legacy network entity, e.g., network entity 602, that does not recognize support of reduced capabilities.

In some aspects, the network entity 602 may reject a connection if the UE 604's capability information indicates support for a feature that is unsupportable by the network entity 602. For example, the UE 604's capability information may include a bit position that indicates support for a feature that was introduced in a later version than is supported by the network entity 602, such that the network entity 602 is not configured with information that indicates the feature associated with the bit position. In this example, in some aspects, the network entity 602 may reject the connection. Additionally or alternatively, the network entity 602 may accept the connection if at least one bit position matches between the UE 604's capability information and the network entity 602's capability information.

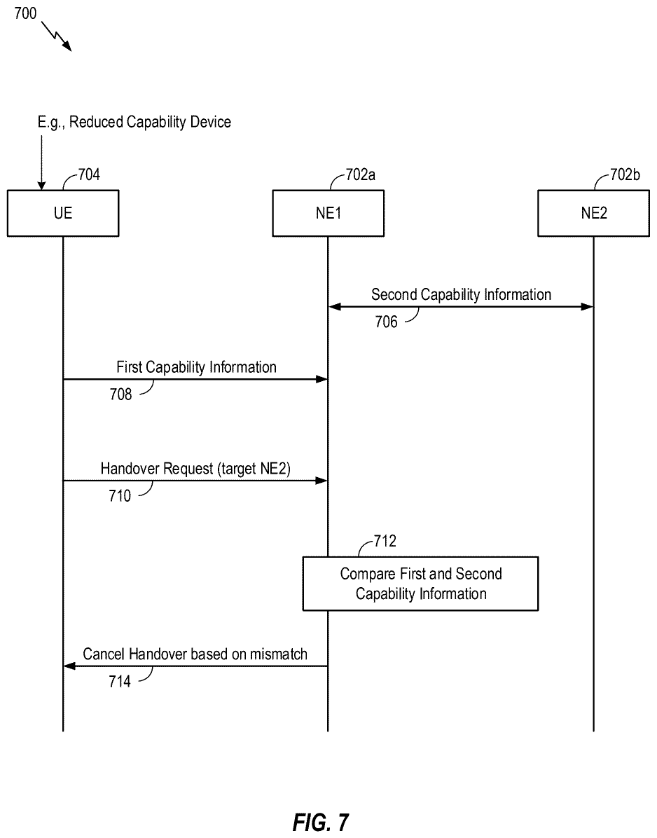

FIG. 7 depicts a process flow 700 for network connection establishment communications between a first network entity 702a, a second network entity 702b, and a UE 704 in a UE mobility context, e.g., a handover of UE 704 between first network entity 702a and second network entity 702b. In some aspects, the first network entity 702a may be an example of the first network entity 502a depicted and described with respect to FIG. 5, and the second network entity 502b may be an example of the second network entity 502b depicted and described with respect to FIG. 5. Similarly, the UE 704 may be an example of UE 504 depicted and described with respect to FIG. 5.

In the context of a handover or mobility operation, such as the example shown in FIG. 5, the first network entity 702a may be referred to as a source network entity and the second network entity 702b may be referred to as a target network entity. The source network entity transfers a connection with a UE, e.g., UE 704, to a target network entity. As with in example of FIG. 6, UE 704 sets the values of the bit positions of the field according to the reduced capability features supported by UE 704, the first network entity 702a implements the field with the values of the bit positions set according to the set of reduced capability features supportable by the first network entity 702a, and second network entity 702b implements the field with the values of the bit positions set according to the set of reduced capability features supportable by the second network entity 702b.

At 706, the first network entity 702 a may exchange second capability information with second network entity 702b, where the second capability information includes the field with the bit positions set according to the features that are supported by the second network entity 702b. The exchange of second capability information may be part of an establishment process in the network of a neighbor relationship (that is, a neighbor relation establishment) between the first network entity 702a and the second network entity 702b.

At 708, UE 704 sets the values of the bit positions in a field of capability information according to the reduced capability features supported by UE 704 and sends first capability information as described in FIG. 6, where the first capability information comprises the field with the bit positions set according to the capabilities of UE 704. In the example of FIG. 7, a connection between UE 704 and the first network entity 702a may already be established, and if the first network entity 702a supports the reduced capability features of UE 704, then at least one bit position of the field is the same between UE 704 and first network entity 702a. However, the first capability information is not expected to include information about the supportable features of the first network entity 702a. Rather, the first capability information refers to the features supported by UE 704.

At 710, UE 704 may identify the second network entity 702 b as a candidate target network entity. As such, UE 704 may send a handover request to the first network entity 702a, as the source network entity, with the second network entity 702b identified as the target network entity.

At 712, the first network entity 702 a may compare the bit positions of the field in the first capability information to the bit positions of the field in the second capability information from second network entity 702b. The first network entity 702a looks for different values in each corresponding bit position between the field in the first capability information and the field in the second capability information, which would indicate which features are supported by the second network entity 702b (even if these features are unsupportable by the first network entity 702a).

At 714, the first network entity 702 a cancels the handover request to transfer UE 704 to second network entity 702b. This cancellation may be due to no values in the bit positions of the field in the first capability information indicating support for a same feature as respective bit positions of the field in the second capability information. For example, the field of the first capability information may indicate “00100” and the field of the second capability information may indicate “01000”, meaning that no bit position indicates support for the same feature at the second network entity 702b and the UE 704. Thus, the first network entity 702a can accept or cancel mobility according to mutual capabilities of the UE 704 and the second network entity 702b, even if the mutual capabilities of the UE 704 and the second network entity 702b are unsupportable by the first network entity 702a.

In certain aspects, UE 704 may send a connection request to the second network entity 702b. In this case, the second network entity 702b receives the connection request directly from the UE 704 and compares the field from the UE 704 to the field of second network entity 702b. A handover is initiated between the first network entity 702a and the second network entity 702b in the event that at least one bit position in both fields has been set to a value that indicates support for a same feature, as described above. Otherwise, the second network entity 702b rejects the connection request and the handover of UE 704 is canceled. In certain aspects, the use of the field may allow the network to quickly reject a handover of a UE with reduced capabilities, from a source network entity, e.g., first network entity 702a, to a target network entity that does not recognize support of reduced capabilities, e.g., second network entity 702b.

Note that the process flows illustrated in FIG. 6 and FIG. 7 are examples of forward compatibility signaling of reduced UE capabilities in a wireless network, and aspects of the present disclosure may be applied to forward compatibility of UE capabilities signaling in a wireless network. Note that the process flows illustrated in FIG. 6 and FIG. 7 are described herein to facilitate an understanding of forward compatibility signaling of reduced UE capabilities in a wireless network, and aspects of the present disclosure may be performed in various manners via alternative or additional signaling and/or operations. In certain aspects, the operations and/or signaling of FIG. 6 and/or FIG. 7 may occur in an order different from that described or depicted, and various actions, operations, and/or signaling may be added, omitted, or combined.

FIG. 8 depicts examples of a field of capability information implemented in network devices within a wireless communications network.

FIG. 8 includes a diagram illustrating an example 800 of the field implemented in a UE, e.g., UE 604 of FIG. 6 or UE 704 of FIG. 7. In the example 800 of FIG. 8, the field in the UE includes bit positions A, B, C, and D corresponding to features supported by the UE, meaning that the UE understands the features corresponding to these bit positions and may set the value of these bit positions according to the reduced capability features that the UE supports, e.g., half-duplex operation or DL modulation order as described above. The field shown in example 800 also includes bit positions E-H that represent features that the UE does not support. These bit positions would not be set by the UE, so a zero value is shown in example 800. The UE may not understand or be configured with information indicating the exact feature corresponding to the “unsupportable feature” bits. In this example, the UE is a reduced capability device because bit position A has been set to a value of one, which means that the UE supports a specific reduced capability feature corresponding to bit position A. The exact feature represented by bit position A is known and understood to the UE and other devices that support that feature.

FIG. 8 also includes a diagram illustrating an example 810 of the field of capability information for a first network entity, e.g., network entity 602 of FIG. 6 or first network entity 702a of FIG. 7. In the example of FIG. 8, the field for the network entity (shown by example 810) includes bit positions A-B corresponding to reduced capability features that are supportable by the first network entity, along with bit positions C-H corresponding to reduced capability features that are unsupportable by the first network entity. As explained in example 800 with respect to the UE, the “unsupportable feature” bits C through H are not set by the first network entity in example 810 and remain zero. In this case, bit position A has been set to a value of one, which means that the first network entity supports a specific reduced capability feature. Further, since bit position A is set to one in both the UE's field (of example 800) and the first network entity's field (of example 810), a comparison of the field between this UE and the first network entity as described in FIG. 6 would indicate a match and a connection request may be accepted between these devices. As used herein, a “match” with regard to a bit position indicates that two devices have indicated support for a feature associated with the bit position. For example, no match occurs with regard to bit position B of example 800 and example 810, since these features are not supported by the UE and the first network entity. However, a match occurs with regard to bit position A of example 800 and example 810.

FIG. 8 also includes an example 820 of the field implemented in a second network entity, e.g., second network entity 702b of FIG. 7. In the example of FIG. 8, the field for the second network entity includes bit positions A-H corresponding to reduced capability features that are supportable by the second network entity, with no bit positions corresponding to reduced capability features that are unsupportable by the second network entity. Therefore, all bit positions shown in example 820 may be set by this network entity to indicate support for a corresponding feature. In example 820, bit positions A, B, D and F have a value of one, which corresponds to a larger set of supportable features for the second network entity that exceeds the capabilities of the UE of example 800 or the first network entity of example 810. However, because bit position A in example 820 is set to a value of one, a comparison of the field (in example 800) between the UE and the second network entity as described in FIG. 7 would indicate a match, and a connection or handover request may be accepted or initiated between these devices.

While the network entity compares all bit positions in the field, in this case, the mismatch of bit positions B, D, and F is ignored. This is because the network entity in example 820 may connect to a UE that implements any one of the features corresponding to bit positions A, as in this case, or B, D, or F. A device implementing the field described herein is expected to accept a connection or initiate a handover if at least one bit position has a matching value at the UE and network entity (that is, indicating support for the same feature).

It should be noted that examples 800, 810 and 820 depict 8 bit positions A-H, but the field is not limited in the number of bit positions and may comprise as many bit positions as needed to correspond to supportable reduced capability features of a network device.

### Example Operations of a Network Entity

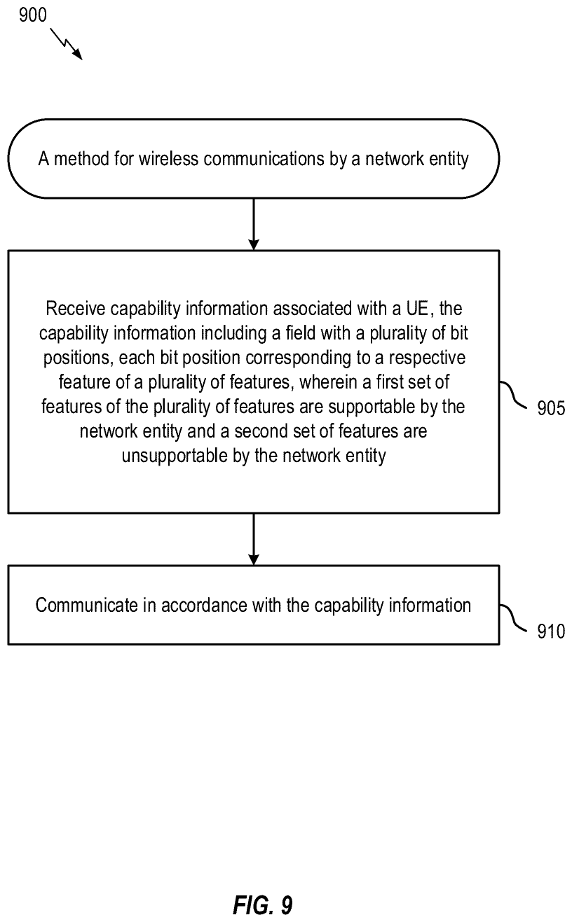

FIG. 9 shows a method 900 for wireless communications by an apparatus, such as BS 102 of FIG. 1, a first network entity 300 or second network entity 302 of FIG. 3, or a disaggregated base station as discussed with respect to FIG. 2.

Method 900 begins at block 905 with receiving capability information associated with a UE, the capability information including a field with a plurality of bit positions, each bit position corresponding to a respective feature of a plurality of features, wherein a first set of features of the plurality of features are supportable by the network entity and a second set of features are unsupportable by the network entity.

Method 900 then proceeds to block 910 with communicating in accordance with the capability information.

In some aspects, the capability information includes a value indicating support for a feature of the second set of features and no values indicating support for any feature of the first set of features, and wherein block 910 includes rejecting a connection from the UE.

In some aspects, the capability information includes a value indicating support for a feature of the first set of features, and wherein block 910 includes accepting a connection from the UE.

In some aspects, one or more features, of the plurality of features, relate to a reduced capability UE configuration.

In some aspects, the first set of features is associated with a first version of a radio access technology and the second set of features is associated with a second version of the radio access technology.

In some aspects, the first version is an earlier version than the second version.

In some aspects, the network entity is configured to support the first version and not the second version.

In some aspects, the capability information is first capability information and the network entity is a source network entity for a mobility operation, wherein the method 900 further comprises receiving second capability information, including the field, from a target network entity of the mobility operation; and initiating, or canceling, the mobility operation based on the first capability information and the second capability information.

In some aspects, initiating, or canceling, the mobility operation based on the first capability information and the second capability information comprises canceling the mobility operation based on there being no match between values of bit positions of the first capability information and corresponding bit positions of the second capability information.

In some aspects, initiating, or canceling, the mobility operation based on the first capability information and the second capability information comprises initiating the mobility operation based on a first value of a particular bit position of the first capability information matching a second value of the particular bit position of the second capability information.

In some aspects, the particular bit position corresponds to a feature of the first set of features.

In some aspects, the particular bit position corresponds to a feature of the second set of features.

In some aspects, receiving the second capability information comprises receiving the second capability information in association with neighbor relation establishment.

In some aspects, the network entity is a target network entity of a mobility operation, wherein block 905 includes receiving the capability information from a source network entity of the mobility operation.

In some aspects, the field is a single field.

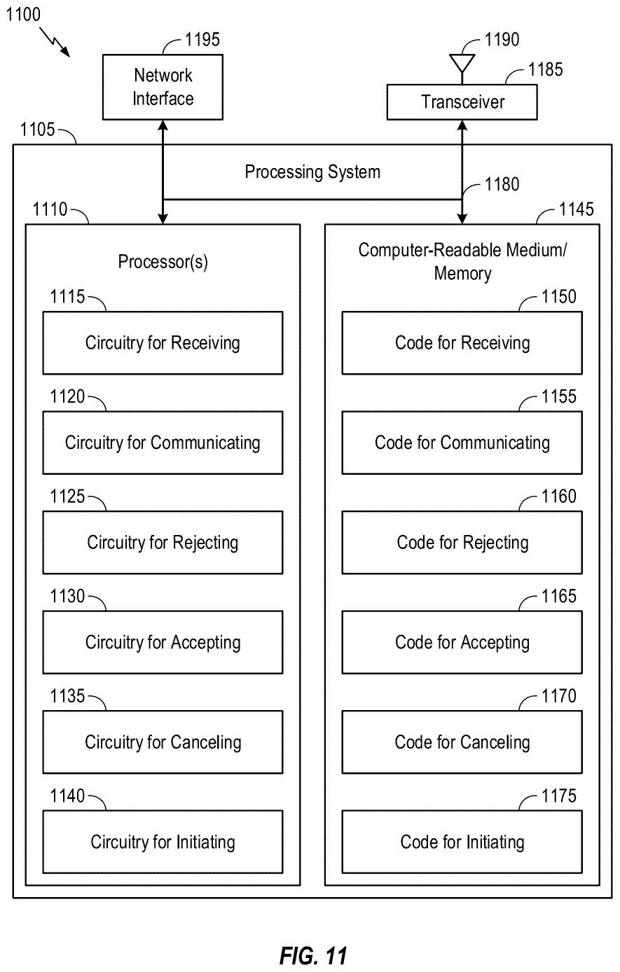

In some aspect, method 900, or any aspect related to it, may be performed by an apparatus, such as communications device 1100 of FIG. 11, which includes various components operable, configured, or adapted to perform the method 900. Communications device 1100 is described below in further detail.

Note that FIG. 9 is just one example of a method, and other methods including fewer, additional, or alternative operations are possible consistent with this disclosure.

### Example Operations of a User Equipment

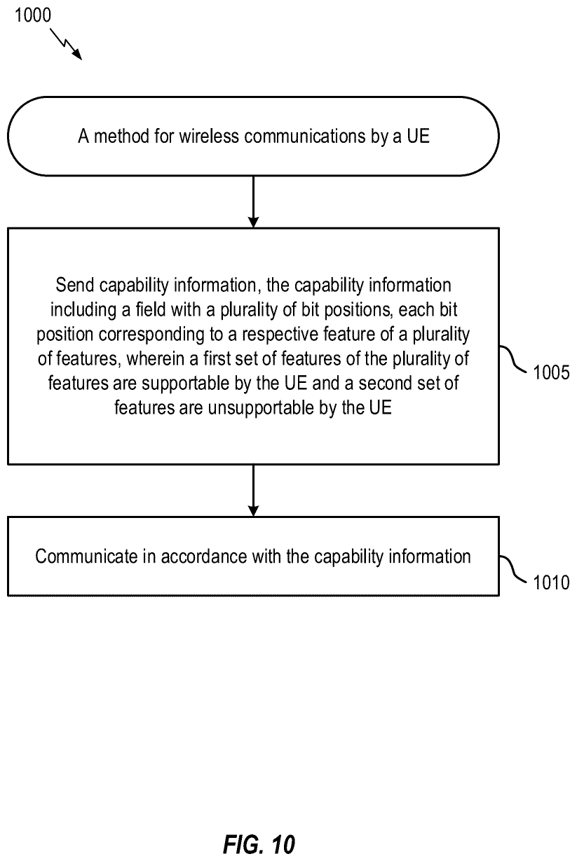

FIG. 10 shows a method 1000 for wireless communications by a UE, such as UE 104 of FIG. 1 or UE 304 of FIG. 3.

Method 1000 begins at block 1005 with sending capability information, the capability information including a field with a plurality of bit positions, each bit position corresponding to a respective feature of a plurality of features, wherein a first set of features of the plurality of features are supportable by the UE and a second set of features are unsupportable by the UE.

Method 1000 then proceeds to block 1010 with communicating in accordance with the capability information.

In some aspects, the capability information includes a value indicating support for a feature of the second set of features and no values indicating support for any feature of the first set of features, and block 1010 includes receiving an acceptance of a connection from a network entity.

In some aspects, one or more features, of the plurality of features, relate to a reduced capability UE configuration.

In some aspects, the first set of features is associated with a first version of a radio access technology and the second set of features is associated with a second version of the radio access technology.

In some aspects, the first version is an earlier version than the second version.

In some aspects, the UE is configured to support the first version and not the second version.

In some aspects, the field is a single field.

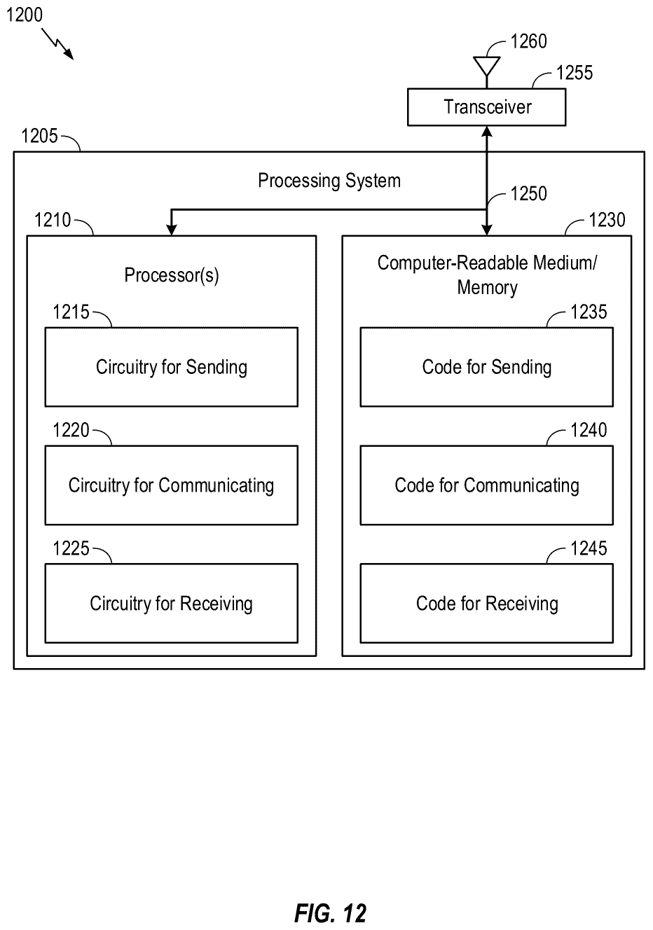

In some aspect, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

### Example Communications Devices

FIG. 11 depicts aspects of an example communications device configured for wireless communications. In some aspects, communications device 1100 is a network entity, such as BS 102 of FIG. 1, first network entity 300 or second network entity 302 of FIG. 3, or a disaggregated base station as discussed with respect to FIG. 2.

The communications device 1100 includes a processing system 1105 coupled to a transceiver 1185 (e.g., a transmitter and/or a receiver) and/or a network interface 1195. The transceiver 1185 is configured to transmit and receive signals for the communications device 1100 via an antenna 1190, such as the various signals as described herein. The network interface 1195 is configured to obtain and send signals for the communications device 1100 via communications link(s), such as a backhaul link, midhaul link, and/or fronthaul link as described herein, such as with respect to FIG. 2. The processing system 1105 may be configured to perform processing functions for the communications device 1100, including processing signals received and/or to be transmitted by the communications device 1100.

The processing system 1105 includes one or more processors 1110 and a computer-readable medium/memory 1145. In various aspects, one or more processors 1110 may be representative of the one or more processors 308, as described with respect to FIG. 3. The one or more processors 1110 are coupled to the computer-readable medium/memory 1145 via a bus 1180. In certain aspects, the computer-readable medium/memory 1145 is configured to store instructions (e.g., computer-executable code), including code 1150-1175, that when executed by the one or more processors 1110, cause the one or more processors 1110 to perform the method 900 described with respect to FIG. 9, or any aspect related to it, including any operations described in relation to FIG. 9. The computer-readable medium/memory 1145 is a non-transitory computer-readable medium/memory. Note that reference to a processor of communications device 1100 performing a function may include one or more processors of communications device 1100 performing that function, such as in a distributed fashion.

In the depicted example, the computer-readable medium/memory 1145 stores code (e.g., executable instructions), including code for receiving 1150, code for communicating 1155, code for rejecting 1160, code for accepting 1165, code for canceling 1170, and code for initiating 1175. Processing of the code 1150-1175 may enable and cause the communications device 1100 to perform the method 900 described with respect to FIG. 9, or any aspect related to it.

The one or more processors 1110 include circuitry configured to implement (e.g., execute) the code stored in the computer-readable medium/memory 1145, including circuitry for receiving 1115, circuitry for communicating 1120, circuitry for rejecting 1125, circuitry for accepting 1130, circuitry for canceling 1135, and circuitry for initiating 1140. Processing with circuitry 1115-1140 may enable and cause the communications device 1100 to perform the method 900 described with respect to FIG. 9, or any aspect related to it.

Various components of the communications device 1100 may provide means for performing the method 900 described with respect to FIG. 9, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1185, antenna 1190, and/or network interface 1195 of the communications device 1100 in FIG. 11, and/or one or more processors 1110 of the communications device 1100 in FIG. 11. Means for communicating, receiving or obtaining may include the one or more transceivers 312, one or more antennas 314, and/or processing system 306 of the first network entity 300 or the second network entity 302 illustrated in FIG. 3, transceiver 1185, antenna 1190, and/or network interface 1195 of the communications device 1100 in FIG. 11, and/or one or more processors 1110 of the communications device 1100 in FIG. 11.

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1255 (e.g., a transmitter and/or a receiver). The transceiver 1255 is configured to transmit and receive signals for the communications device 1200 via an antenna 1260, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1230. In various aspects, the one or more processors 1210 may be representative of the one or more processors 318 described with respect to FIG. 3. The one or more processors 1210 are coupled to a computer-readable medium/memory 1230 via a bus 1250. In some aspects, the computer-readable medium/memory 1230 may be representative of the one or more memories 320 described with respect to FIG. 3. The computer-readable medium/memory 1230 is a non-transitory computer-readable medium/memory. In certain aspects, the computer-readable medium/memory 1230 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1230 stores code (e.g., executable instructions), including code for sending 1235, code for communicating 1240, and code for receiving 1245. Processing of the code 1235-1245 may enable and cause the communications device 1200 to perform the method 1000 described with respect to FIG. 10, or any aspect related to it.

The one or more processors 1210 include circuitry configured to implement (e.g., execute) the code stored in the computer-readable medium/memory 1230, including circuitry for sending 1215, circuitry for communicating 1220, and circuitry for receiving 1225. Processing with circuitry 1215-1225 may enable and cause the communications device 1200 to perform the method 1000 described with respect to FIG. 10, or any aspect related to it.

More generally, means for communicating, transmitting, sending or outputting for transmission may include the one or more transceivers 324, one or more antenna 322 and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1255 and/or antenna 1260 of the communications device 1200 in FIG. 12, and/or one or more processors 1210 of the communications device 1200 in FIG. 12.

### EXAMPLE CLAUSES

Implementation examples are described in the following numbered clauses:

Clause 1: A method for wireless communications by a network entity comprising: receiving capability information associated with a UE, the capability information including a field with a plurality of bit positions, each bit position corresponding to a respective feature of a plurality of features, wherein a first set of features of the plurality of features are supportable by the network entity and a second set of features are unsupportable by the network entity; and communicating in accordance with the capability information.

Clause 2: The method of Clause 1, wherein the capability information includes a value indicating support for a feature of the second set of features and no values indicating support for any feature of the first set of features, and wherein communicating in accordance with the capability information comprises rejecting a connection from the UE.

Clause 3: The method of any one of Clauses 1-2, wherein the capability information includes a value indicating support for a feature of the first set of features, and wherein communicating in accordance with the capability information comprises accepting a connection from the UE.

Clause 4: The method of any one of Clauses 1-3, wherein one or more features, of the plurality of features, relate to a reduced capability UE configuration.

Clause 5: The method of any one of Clauses 1-4, wherein the first set of features is associated with a first version of a radio access technology and the second set of features is associated with a second version of the radio access technology.

Clause 6: The method of Clause 5, wherein the first version is an earlier version than the second version.

Clause 7: The method of Clause 5, wherein the network entity is configured to support the first version and not the second version.

Clause 8: The method of any one of Clauses 1-7, wherein the capability information is first capability information and the network entity is a source network entity for a mobility operation, wherein the method further comprises: receiving second capability information, including the field, from a target network entity of the mobility operation; and initiating, or canceling, the mobility operation based on the first capability and the second capability information.

Clause 9: The method of Clause 8, wherein initiating, or canceling, the mobility operation based on the first capability information and the second capability information comprises canceling the mobility operation based on there being no match between values of bit positions of the first capability information and corresponding bit positions of the second capability information.

Clause 10: The method of Clause 8, wherein initiating, or canceling, the mobility operation based on the first capability information and the second capability information comprises initiating the mobility operation based on a first value of a particular bit position of the first capability information matching a second value of the particular bit position of the second capability information.

Clause 11: The method of Clause 10, wherein the particular bit position corresponds to a feature of the first set of features.

Clause 12: The method of Clause 10, wherein the particular bit position corresponds to a feature of the second set of features.

Clause 13: The method of Clause 8, wherein receiving the second capability information comprises receiving the second capability information in association with neighbor relation establishment.

Clause 14: The method of any one of Clauses 1-13, wherein the network entity is a target network entity of a mobility operation, wherein receiving the capability information comprises receiving the capability information from a source network entity of the mobility operation.

Clause 15: The method of any one of Clauses 1-14, wherein the field is a single field.

Clause 16: A method for wireless communications by a UE comprising: sending capability information, the capability information including a field with a plurality of bit positions, each bit position corresponding to a respective feature of a plurality of features, wherein a first set of features of the plurality of features are supportable by the UE and a second set of features are unsupportable by the UE; and communicating in accordance with the capability information.

Clause 17: The method of Clause 16, wherein the capability information includes a value indicating support for a feature of the second set of features and no values indicating support for any feature of the first set of features, and communicating in accordance with the capability information comprises receiving an acceptance of a connection from a network entity.

Clause 18: The method of any one of Clauses 16-17, wherein one or more features, of the plurality of features, relate to a reduced capability UE configuration.

Clause 19: The method of any one of Clauses 16-18, wherein the first set of features is associated with a first version of a radio access technology and the second set of features is associated with a second version of the radio access technology.

Clause 20: The method of Clause 19, wherein the first version is an earlier version than the second version.

Clause 21: The method of Clause 19, wherein the UE is configured to support the first version and not the second version.

Clause 22: The method of Clause 19, wherein the field is a single field.

Clause 23: One or more apparatuses, comprising: one or more memories comprising executable instructions; and one or more processors configured to execute the executable instructions and cause the one or more apparatuses to perform a method in accordance with any one of Clauses 1-22.

Clause 24: One or more apparatuses configured for wireless communications, comprising: one or more memories; and one or more processors, coupled to the one or more memories, configured to cause the one or more apparatuses to perform a method in accordance with any one of Clauses 1-22.

Clause 25: One or more apparatuses configured for wireless communications, comprising: one or more memories; and one or more processors, coupled to the one or more memories, configured to perform a method in accordance with any one of Clauses 1-22.

Clause 26: One or more apparatuses, comprising means for performing a method in accordance with any one of Clauses 1-22.

Clause 27: One or more non-transitory computer-readable media comprising executable instructions that, when executed by one or more processors of one or more apparatuses, cause the one or more apparatuses to perform a method in accordance with any one of Clauses 1-22.

Clause 28: One or more computer program products embodied on one or more computer-readable storage media comprising code for performing a method in accordance with any one of Clauses 1-22.

Clause 29: One or more apparatuses configured for wireless communications, comprising: a processing system that includes one or more processors and one or more memories coupled with the one or more processors, the processing system configured to cause the one or more apparatuses to perform a method in accordance with any one of Clauses 1-22.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a network entity to:
receive capability information associated with a user equipment (UE), the capability information including a field with a plurality of bit positions, each bit position corresponding to a respective feature of a plurality of features, wherein a first set of features of the plurality of features are supportable by the network entity and a second set of features are unsupportable by the network entity; and
communicate in accordance with the capability information.

2. The apparatus of claim 1, wherein the capability information includes a value indicating support for a feature of the second set of features and no values indicating support for any feature of the first set of features, and wherein to cause the network entity to communicate in accordance with the capability information, the processing system is configured to cause the network entity to reject a connection from the UE.

3. The apparatus of claim 1, wherein the capability information includes a value indicating support for a feature of the first set of features, and wherein to cause the network entity to communicate in accordance with the capability information, the processing system is configured to cause the network entity to accept a connection from the UE based on the network entity supporting the feature.

4. The apparatus of claim 1, wherein one or more features, of the plurality of features, relate to a reduced capability UE configuration.

5. The apparatus of claim 1, wherein the first set of features is associated with a first version of a radio access technology and the second set of features is associated with a second version of the radio access technology.

6. The apparatus of claim 5, wherein the first version is an earlier version than the second version.

7. The apparatus of claim 5, wherein the network entity is configured to support the first version and not the second version.

8. The apparatus of claim 1, wherein the capability information is first capability information and the network entity is a source network entity for a mobility operation, wherein the processing system is configured to cause the source network entity to:
receive second capability information, including the field, from a target network entity of the mobility operation; and
initiate, or cancel, the mobility operation based on the first capability information and the second capability information.

9. The apparatus of claim 8, wherein to cause the source network entity to initiate, or cancel, the mobility operation based on the first capability information and the second capability information, the processing system is configured to cause the source network entity to cancel the mobility operation based on there being no match between values of bit positions of the first capability information and corresponding bit positions of the second capability information.

10. The apparatus of claim 8, wherein to cause the source network entity to initiate, or cancel, the mobility operation based on the first capability information and the second capability information, the processing system is configured to cause the source network entity to initiate the mobility operation based on a first value of a particular bit position of the first capability information matching a second value of the particular bit position of the second capability information.

11. The apparatus of claim 10, wherein the particular bit position corresponds to a feature of the first set of features and the first value and the second value indicate support for the feature.

12. The apparatus of claim 10, wherein the particular bit position corresponds to a feature of the second set of features and the first value and the second value indicate support for the feature.

13. The apparatus of claim 8, wherein to cause the source network entity to receive the second capability information, the processing system is configured to cause the source network entity to receive the second capability information in association with neighbor relation establishment.

14. The apparatus of claim 1, wherein the network entity is a target network entity of a mobility operation, wherein to cause the target network entity to receive the capability information, the processing system is configured to cause the target network entity to receive the capability information from a source network entity of the mobility operation.

15. The apparatus of claim 1, wherein the field is a single field.

16. An apparatus for wireless communications, comprising a processing system that includes one or more processors and one or more memories coupled with the one or more processors, the processing system configured to cause a user equipment (UE) to:
send capability information, the capability information including a field with a plurality of bit positions, each bit position corresponding to a respective feature of a plurality of features, wherein a first set of features of the plurality of features are supportable by the UE and a second set of features are unsupportable by the UE; and
communicate in accordance with the capability information.

17. The apparatus of claim 16, wherein the capability information includes a value indicating support for a feature of the second set of features and no values indicating support for any feature of the first set of features, and wherein to cause the UE to communicate in accordance with the capability information, the processing system is configured to cause the UE to receive an acceptance of a connection from a network entity.

18. The apparatus of claim 16, wherein one or more features, of the plurality of features, relate to a reduced capability UE configuration.

19. The apparatus of claim 16, wherein the first set of features is associated with a first version of a radio access technology and the second set of features is associated with a second version of the radio access technology.

20. A method for wireless communications by a network entity comprising:
receiving capability information associated with a user equipment (UE), the capability information including a field with a plurality of bit positions, each bit position corresponding to a respective feature of a plurality of features, wherein a first set of features of the plurality of features are supportable by the network entity and a second set of features are unsupportable by the network entity; and
communicating in accordance with the capability information.
